(19) United States
(12) Patent Application Publication
(10) Pub. No.: US 2010/0288829 A1
(43) Pub. Date: Nov. 18, 2010

(54) Systems and Techniques for Controlling the Selection and/or Removal of Packages from a Transport Vehicle

(76) Inventor: Ernesto Nebit, San Diego, CA (US)

Correspondence Address: NEIL STEINBERG, 2300 M STREET, N.W., Suite 800, WASHINGTON, DC, 20037, US

(21) Appl. No.: 12/779,002

(22) Filed: May 12, 2010

Related U.S. Application Data
(60) Provisional application No. 61/177,394, filed on May 12, 2009.

(51) Int. Cl. G06F 17/00; H04Q 5/22; G06K 7/10

(52) U.S. Cl. 235/375; 340/10.1

(57) ABSTRACT

A system for selecting a package for removal from a transport vehicle, the system comprises a package identification data input device including a data input device and an operator interface, wherein the data input device is configured to input package identification data corresponding to a package on the transport vehicle; and a computer, coupled to the package identification data input device, to receive data corresponding to the package, and based on the selection criteria, responsively provide data which are representative of instruction whether to select the package for removal from the transport vehicle, wherein the selection criteria includes a distance from an arrival port/depot to the destination of the passenger associated with the package. A method for selecting a package for removal from a transport vehicle, the method comprises detecting package identification data corresponding to a package on the transport vehicle using a package identification data input device; transmitting the package identification data to a computer; determining whether to select the package for removal from the transport vehicle based on selection criteria including a distance from an arrival port/depot to a destination of the passenger associated with the package; and transmitting data which are representative of instruction whether to select the package for removal from the transport vehicle to the package identification data input device.

### RELATED APPLICATION

This non-provisional application claims priority to U.S. Provisional Application Ser. No. 61/177,394, entitled “Systems and Techniques for Controlling the Selection and/or Removal of Packages from a Transport Vehicle”, filed May 12, 2009; the contents of this U.S. Provisional Application are incorporated by reference herein, in their entirety.

### INTRODUCTION

The present inventions relate to systems and techniques for controlling the selection and/or removal of packages (for example, passenger luggage) from a transportation vehicle (for example, a bus, a train, boat or an aircraft) in a situation where, for example, the delivery of one or more packages of a passenger is to be delayed (for example, due to environmental conditions, such as weather, and/or due to size or weight constraints, limitations and/or considerations of the one or more packages). The selection and/or removal of packages from a transportation vehicle may be based on one or more criteria including, for example, the distance from the arrival port/depot to the destination of the passenger associated with one or more of such packages, the final destination of such passenger, traveling class of such passenger, the “status” of such passenger on the carrier, transportation vehicle scheduling to the same or a predetermined arrival port/depot (for example, a port/depot that is relatively close to the arrival port/depot), and/or number, weight and/or size of such packages.

### BRIEF DESCRIPTION OF THE DRAWINGS

In the course of the detailed description to follow, reference will be made to the attached drawings. These drawings show different aspects of the present inventions and, where appropriate, reference numerals illustrating like structures, components, materials and/or elements in different figures are labeled similarly. It is understood that various combinations of the structures, components, materials and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed and/or illustrated separately herein.

FIGS. 1A and 1B are schematic block diagram representations of package identification information/data input apparatus embodiments, according to at least certain aspects of the present inventions;

FIG. 1C is an illustration of a package identification information/data input apparatus embodiment;

FIGS. 1D and 1E are schematic block diagram representations of package identification information/data input apparatus embodiments, according to at least certain aspects of the present inventions, wherein the operator interface includes at least a speaker to output audio information;

FIGS. 2A-2C are exemplary embodiments of interface techniques of exemplary package identification information/data input apparatus with an external computer (for example, local or central computer), according to at least certain aspects of certain embodiments of the present inventions;

FIGS. 3A-3C are exemplary embodiments of interface techniques of a plurality of exemplary package identification information/data input apparatuses with an external computer (for example, local or central computer), according to at least certain aspects of certain embodiments of the present inventions;

FIG. 4 is an exemplary embodiment of interface techniques of the package identification information/data input apparatus embodiment of FIG. 1C and an external computer; and

FIGS. 5A-5C are exemplary embodiments of interface techniques of exemplary package identification information/data input apparatus with an external computer (for example, local or central computer), according to at least certain aspects of certain embodiments of the present inventions.

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DETAILED DESCRIPTION

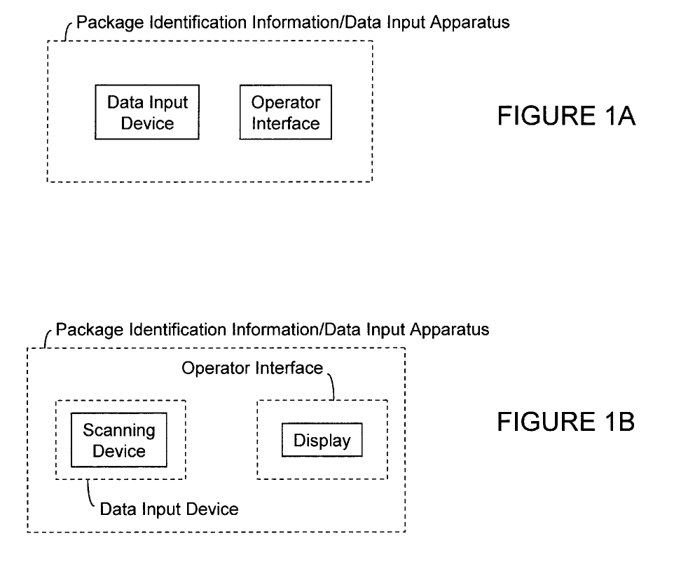

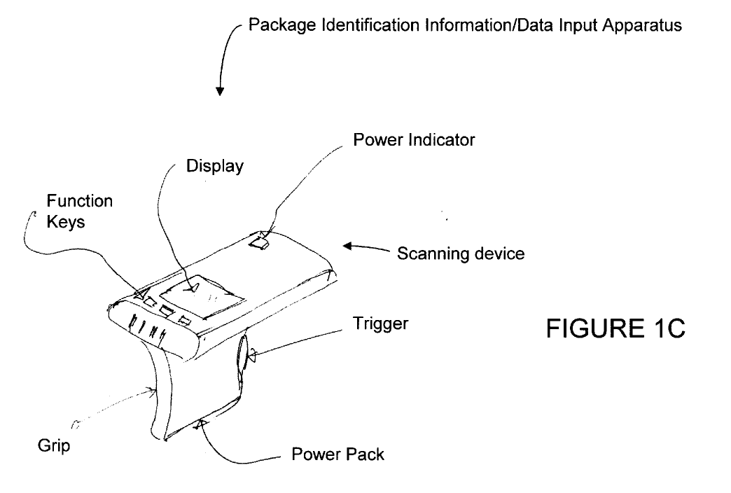

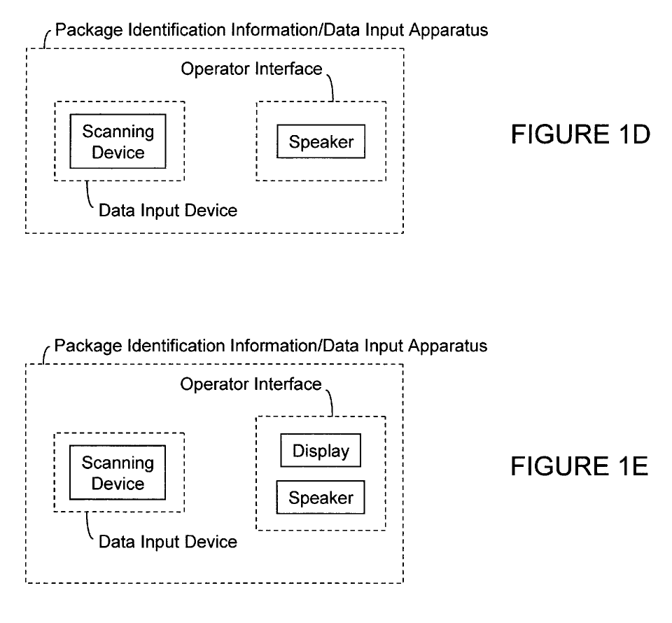

There are many inventions described and illustrated herein. In one aspect, with reference to FIG. 1A, the present inventions include an apparatus (whether or not hand-held) that provides package selection and/or removal information to a user, worker and/or operator (for example, a user, worker and/or operator of the carrier or a contractor thereof). In response to such package selection and/or removal information, the user, worker and/or operator may select, remove and/or divert the package from the transportation vehicle for later or different delivery, for example, on the same or different vehicle (for example, delivery on a later departing bus, train, boat or aircraft to, for example, the same location).

The package identification information/data apparatus may include an operator interface to audibly and/or visually provide package selection and/or removal information to the user, worker and/or operator. For example, the package identification information/data apparatus may include a display (for example, an LCD display) or speaker to instruct the user, worker and/or operator to select, remove and/or divert the package from the transportation vehicle for later or different delivery, for example, on the same or different vehicle (for example, delivery on a later departing bus, train, boat or aircraft to, for example, the same location).

In one embodiment, the apparatus is a hand-held device wherein the user, worker and/or operator inputs package identification information or data and, in response, the hand-held device provides such package selection and/or removal information. The user, worker and/or operator may then select, remove and/or divert the package from the transportation vehicle for later or different delivery, for example, on the same or different vehicle.

The user, worker and/or operator may input package identification information or data into the apparatus via “scanning” (for example, a bar code or an RFID tag) the package identification information or data which is associated with the package. (See, for example, FIGS. 1B-1E). In addition thereto, or in lieu thereof, the user, worker and/or operator may “manually” input such package identification information or data, for example, via a keypad or keyboard (wherein the keystrokes or the like are representative of the package identification information or data) and/or via a microphone (wherein the speech/sound is representative of the package identification information or data). Indeed, any form of input of the package identification information or data which is associated with the package is intended to fall within the scope of the present invention.

As noted above, an operator interface may audibly or visually provide such package selection and/or removal information to the user, worker and/or operator. (See, for example, FIGS. 1B-1E). For example, a hand-held device may include a display (for example, an LCD display) or speaker to instruct the user, worker and/or operator to select, remove and/or divert the package from the transportation vehicle for later or different delivery.

In another embodiment, the present inventions include an apparatus that, in response to package selection and/or removal information, selects, removes and/or diverts the package for later or different delivery, for example, on the same or different vehicle (for example, delivery on a later departing bus, train, boat or aircraft to, for example, the same location). In this embodiment, rather than the user, worker and/or operator selecting, removing and/or diverting the package from the transportation vehicle for later or different delivery, an apparatus (for example, a robotic arm or a conveyer) selects, removes and/or diverts the package for later or different delivery.

With reference to FIG. 1C, package identification information/data input apparatus may be a hand-held device including a scanning device to input or detect package identification information/data which may be, for example, indicated in a barcode form or an RFID on the package. The scanning device may responsively acquire the package identification information/data via a trigger.

In addition, the hand-held device of FIG. 1C may visually provide package selection and/or removal information to the user, worker and/or operator. For example, the hand-held device may include a display (for example, an LCD display) to advise or instruct the user, worker and/or operator to select, remove and/or divert the package from the transportation vehicle for later or different delivery, for example, on the same or different vehicle (for example, delivery on a later departing bus, train, boat or aircraft to, for example, the same location).

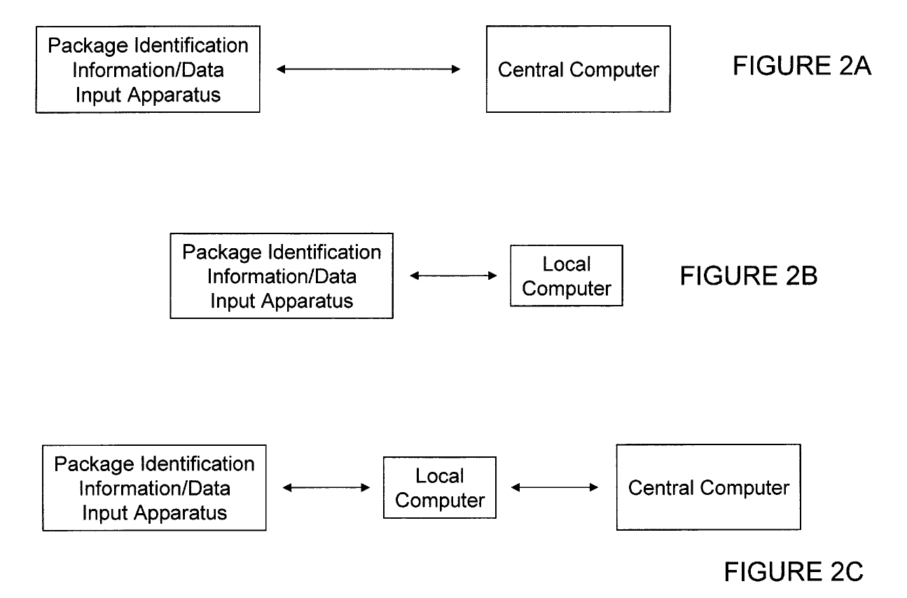

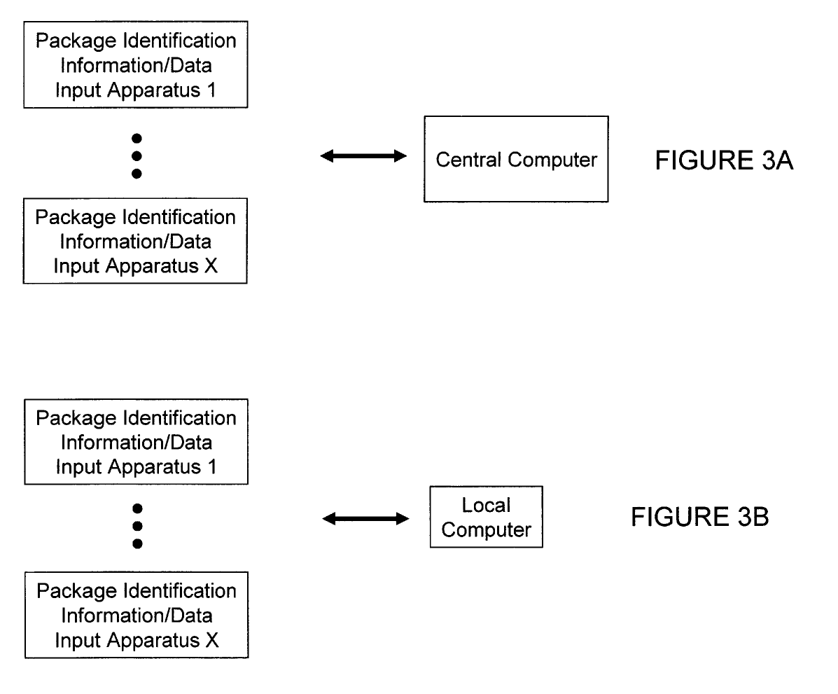

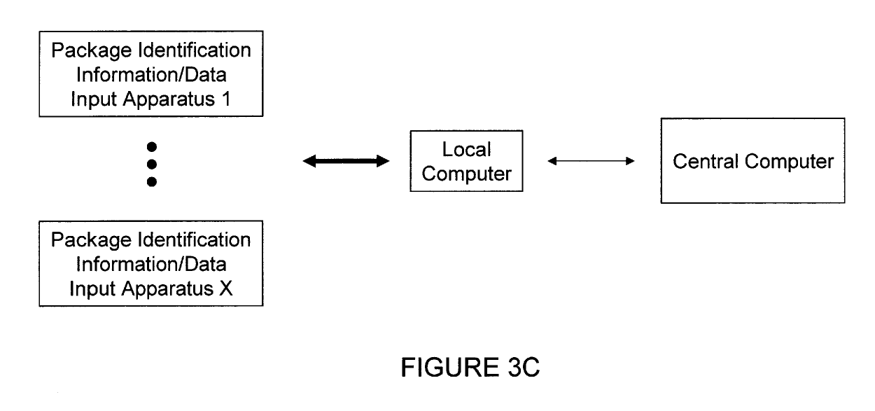

The package selection and/or removal information may be determined in the package identification information/data input apparatus and/or remotely with respect thereto, for example, a local and/or central computer. (See, for example, FIGS. 2A-2C). The remote computer may provide package selection and/or removal information to one information/data input apparatus or a plurality of information/data input apparatuses. (See, for example, FIGS. 2A-2C and 3A-3C).

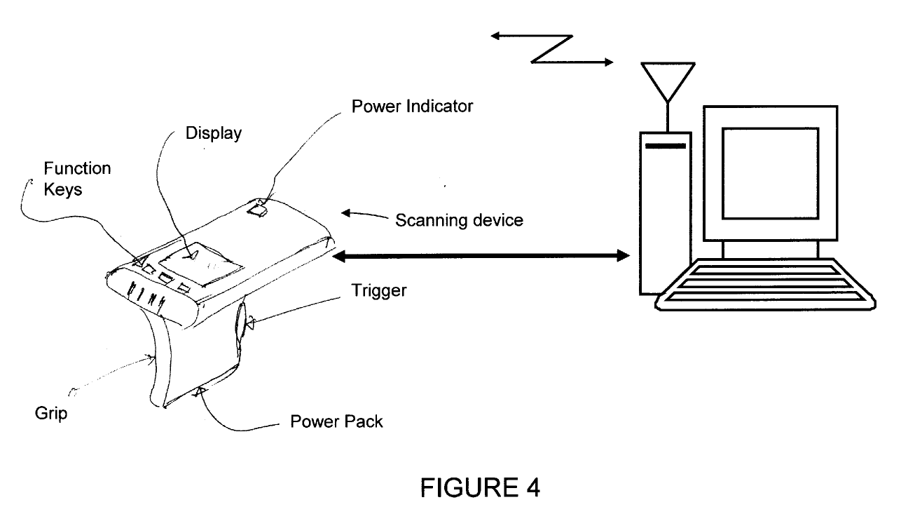

The method of communication between the package identification information/data input apparatus(es) and/or remote station (for example, a local and/or central computer) may be wired or wireless. (See, for example, FIG. 4 wherein the package identification information/data input apparatus is represented by the hand-held type scanning device) Indeed, any form of communications between the package identification information/data input apparatus(es) and/or remote station, whether now known or later developed, is intended to fall within the scope of the present inventions.

The package identification information/data input apparatus and/or remote computer may employ one or more criteria to determine, select, designate and/or identify which packages to select and/or remove from the transportation vehicle. As noted above, such criteria may include, for example, the distance from the arrival port/depot to the destination of the passenger associated with one or more of such packages, the final destination of such passenger, traveling class of such passenger, the “status” of such passenger on the carrier, transportation vehicle scheduling to the same or a predetermined arrival port/depot (for example, a port/depot that is relatively close to the arrival port/depot), and/or number, weight and/or size of such packages. The information/data input apparatus and/or remote computer may be suitably programmed to employ one or more of such criteria.

The criteria employed to determine, select, designate and/or identify which packages to select and/or remove from the transportation vehicle may be weighted such that one or more criteria may be “important” than one or more of the other criteria when determining, selecting designating and/or identifying which packages to select and/or remove from the transportation vehicle. For example, a given status on the carrier (for example, “elite or “premium” status may determine that packages (for example, luggage) associated with the passenger may not be selected and/or removed from the transportation vehicle. In another embodiment, the distance from the arrival port/depot to the destination of the passenger associated with one or more of such packages may be weighted more heavily than the traveling class of such passenger and/or the number, weight and/or size of such packages.

Notably, any combination or permutation of criteria for determining, selecting, designating and/or identifying which packages to select and/or remove from the transportation vehicle is intended to fall within the scope of the present inventions. Moreover, any weighting of such criteria is also intended to fall within the scope of the present inventions.

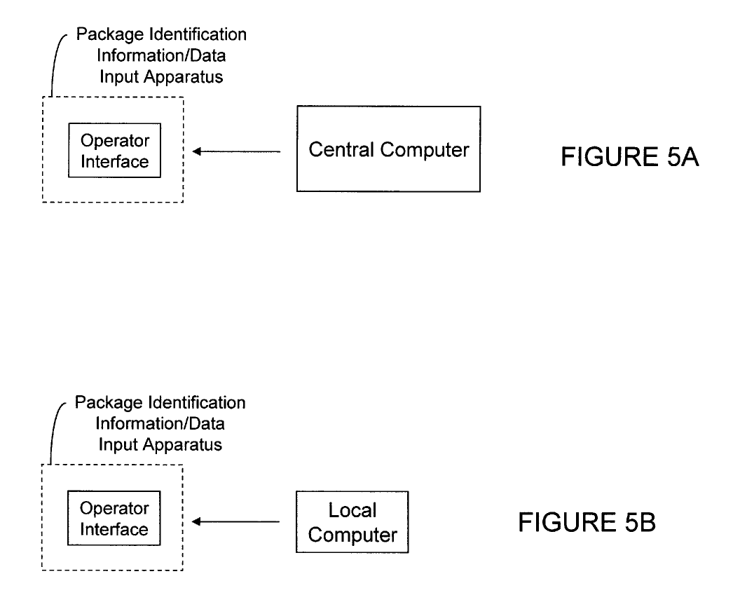

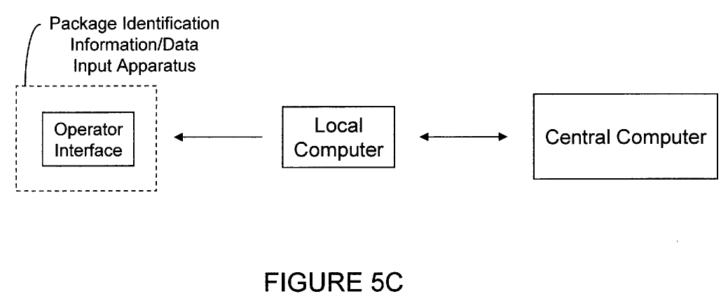

In another embodiment, the information/data input apparatus includes an operator interface and not input device and, in this embodiment, instructs the user, worker and/or operator to select, remove and/or divert the package from the transportation vehicle for later or different delivery, for example, on the same or different vehicle (for example, delivery on a later departing bus, train, boat or aircraft to, for example, the same location) without package identification information or data. In this embodiment, the user, worker and/or operator to select, remove and/or divert the package from the transportation vehicle for later or different delivery based on instructions from the remote computer. (See, for example, FIGS. 5A-5C). That is, in response to such package selection and/or removal information from the remote computer, the user, worker and/or operator may select, remove and/or divert the package from the transportation vehicle for later or different delivery, for example, on the same or different vehicle (for example, delivery on a later departing bus, train, boat or aircraft to, for example, the same location). Notably, the remote computer may employ any of the techniques for determining, selecting, designating and/or identifying which packages to select and/or remove from the transportation vehicle described herein.

In one particular embodiment, the package identification information/data input apparatus may include a scanning device that is employed by the airline industry to scan a bag tag which was generated by, for example, the ticket counter at the time of passenger check-in. The scanning device provides baggage service associate (BSA) with information which is representative of the distance between the arrival or final arrival airport (in the event of a connection) and final place or domain of the passenger. As described, the domain may be the passenger's final destination such as home, hotel or a place where the luggage will be delivered in the event the passenger's luggage is removed (for example, “bumped off”) the scheduled flight of the passenger.

Through the use of zip codes, for example, the package identification information/data input apparatus will generate a distance (for example, in miles or kilometers) between the arrival airport and the passenger's final place or domain. With this method, the BSA has knowledge as to how far the luggage will be going between the arrival airport and the passenger's final destination.

Notably, the Pathfinder MX1948 may be modified to include the circuitry and techniques described and/or illustrated herein. The modified Pathfinder MX1948 may include the existing functions/programs on Gemini scanner using the Apollo program currently in use in the system. With that in mind, a hand-held package identification information or data input device (for example, a modified Pathfinder MX1948) facilitates user, worker and/or operator data input via scanning (for example, a bar code or an RFID tag) the package identification information or data which is associated with the package (on, for example, the bag tag) may implement the following functions:

1. The hand-held package identification information or data input device, which in this particular embodiment is a hand-held scanner type input device may display or provide the distance (in miles or kilometers) between the port of arrival/destination and the passenger's final destination (for example, home, hotel) using a zip code or the like (for example, address or relative zone) provided on the passenger's claim or bag tag.

Note: Passenger's final destination/domain may include:
A. Home address
B. Hotel or resort
C. Where the bag should be delivered in the event the bag has been mis-boarded.

2. The hand-held scanner may display or provide, on a passenger or group basis, the number of bags and/or the physical characteristics thereof (for example, weight, size, etc).

3. The hand-held scanner may generate a visual and/or audio instruction/warning in the event that the final destination/address is out of bounce (meaning outside the country's domain or border) or beyond a predetermined distance from the arrival or destination port.

4. The hand-held scanner may generate zip codes or the like which may be incorporated into a memory within the hand-held scanner.

Notably, the present inventions may facilitate providing the BSA the tool to know the distance between the airport and a passenger's final domain, thereby giving information on how much expenses would be incurred in the delivery should that particular bag be held off, removed or bumped off that flight. The higher the number that shows in the scanner, the higher the expenses that will be incurred.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the embodiments, features, attributes and advantages of the inventions described and illustrated herein are not exhaustive and it should be understood that such other, similar, as well as different, embodiments, features, attributes and advantages of the present inventions are within the scope of the present inventions.

Importantly, the present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, those permutations and combinations are not discussed separately herein.

As such, the embodiments described and/or illustrated of the present inventions are merely exemplary. They are not intended to be exhaustive or to limit the inventions to the precise circuitry, techniques, and/or configurations disclosed. Many modifications and variations are possible in light of the above teaching. It is to be understood that other embodiments may be utilized and operational changes may be made without departing from the scope of the present inventions. As such, the foregoing description of the exemplary embodiments of the inventions has been presented for the purposes of illustration and description. Many modifications and variations are possible in light of the above teaching. It is intended that the scope of the inventions not be limited solely to the description above.

It should be noted that the term “circuit” may mean, among other things, a single component (for example, electrical/electronic and/or microelectromechanical) or a multiplicity of components (whether in integrated circuit form or otherwise), which are active and/or passive, and which are coupled together to provide or perform a desired function. The term “circuitry” may mean, among other things, a circuit (whether integrated or otherwise), a group of such circuits, one or more processors, one or more state machines, one or more processors implementing software, one or more gate arrays, programmable gate arrays and/or field programmable gate arrays, or a combination of one or more circuits (whether integrated or otherwise), one or more state machines, one or more processors, one or more processors implementing software, one or more gate arrays, programmable gate arrays and/or field programmable gate arrays. The term “data” may mean, among other things, a current or voltage signal(s) whether in an analog or a digital form.

Notably, the various circuitry described and/or illustrated herein (or portions and/or combinations thereof) may be integrated or may be implemented using a plurality of discrete logic, whether a state machine, a special or general purpose processor (suitably programmed) and/or a field programmable gate array (or combinations thereof). All permutations and/or combinations of integrated, discrete, hardwired and programmable circuitry (which is programmed, for example, via software) for implementing the analog-to-digital converter circuitry, image generation circuitry, output format circuitry, and/or synchronization circuitry are intended to fall within the scope of the present inventions.

What is claimed is:

1. A system for selecting a package for removal from a transport vehicle, wherein the package is associated with a passenger on the transport vehicle, the system comprising:
a package identification data input device including a data input device and an operator interface, wherein the data input device is configured to input package identification data corresponding to a package on the transport vehicle; and
a computer, coupled to the package identification data input device, to receive data corresponding to the package, and based on the selection criteria, responsively provide data which are representative of instruction whether to select the package for removal from the transport vehicle, wherein the selection criteria includes a distance from an arrival port/depot to a destination of the passenger associated with the package.

2. The system of claim 1 wherein the package identification data input device includes a barcode reader and a visual display to visually display the instruction whether to select the package for removal from the transport vehicle.

3. The system of claim 1 wherein the selection criteria further includes: (i) a traveling class of the passenger, (ii) a status of such passenger on a carrier associated with the transport vehicle, (iii) transportation vehicle scheduling to the same or a predetermined arrival port/depot, or (iv) one or more physical characteristics of the package.

4. The system of claim 1 wherein the computer is a local with respect to the package identification data input device.

5. The system of claim 1 wherein the package identification data input device includes a speaker to audibly output the instruction whether to select the package for removal from the transport vehicle.

6. The system of claim 1 wherein the package identification data input device includes an RFID reader and a visual display to visually display the instruction whether to select the package for removal from the transport vehicle.

7. The system of claim 1 wherein the package identification data input device includes a barcode reader and a speaker to audibly output the instruction whether to select the package for removal from the transport vehicle.

8. The system of claim 1 wherein the package identification data input device includes a barcode reader, a display to visually display the instruction whether to select the package for removal from the transport vehicle, and a speaker to audibly output the instruction whether to select the package for removal from the transport vehicle.

9. A method for selecting a package for removal from a transport vehicle, wherein the package is associated with a passenger on the transport vehicle, the method comprising:
detecting package identification data corresponding to a package on the transport vehicle using a package identification data input device;
transmitting the package identification data to a computer;
determining whether to select the package for removal from the transport vehicle based on selection criteria including a distance from an arrival port/depot to a destination of the passenger associated with the package; and
transmitting data which are representative of instruction whether to select the package for removal from the transport vehicle to the package identification data input device.

10. The method of claim 9 wherein detecting package identification data further includes reading a barcode which is representative of package identification data.

11. The method of claim 9 further including visually displaying the instructions whether to select the package for removal from the transport vehicle.

12. The method of claim 9 wherein the selection criteria further includes: (i) a traveling class of the passenger, (ii) a status of such passenger on a carrier associated with the transport vehicle, (iii) transportation vehicle scheduling to the same or a predetermined arrival port/depot, or (iv) one or more physical characteristics of the package.

13. The method of claim 9 wherein the selection criteria further includes at least two additional criteria selected from the list of: (i) a traveling class of the passenger, (ii) a status of such passenger on a carrier associated with the transport vehicle, (iii) transportation vehicle scheduling to the same or a predetermined arrival port/depot, and (iv) one or more physical characteristics of the package.

14. The method of claim 9 further including audibly outputting the instructions whether to select the package for removal from the transport vehicle.
